(19) United States
(12) Patent Application Publication
(10) Pub. No.: US 2013/0309563 A1
(43) Pub. Date: Nov. 21, 2013

(54) COMPOSITE ANODE FROM SILICON KERF

(71) Applicants: WANLI XU, Baton Rouge, LA (US); YURI SOLOMENTSEV, Baton Rouge, LA (US); JOHN T. FUSSELL, Baton Rouge, LA (US)

(72) Inventors: WANLI XU, Baton Rouge, LA (US); YURI SOLOMENTSEV, Baton Rouge, LA (US); JOHN T. FUSSELL, Baton Rouge, LA (US)

(73) Assignee: ELECTROCHEMICAL MATERIALS, LLC, BATON ROUGE, LA (US)

(21) Appl. No.: 13/653,524

(22) Filed: Oct. 17, 2012

(51) Int. Cl. H01M 4/36

(52) U.S. Cl. CPC H01M 4/362
USPC 429/199; 429/211; 429/188

(57) ABSTRACT

The disclosure relates to a composite anode for a lithium rechargeable battery comprising silicon particles from kerf. Said silicon particles are mixed with carbonaceous materials, other anode active materials and a polymer binder, and formed into a lithium insertion anode for a lithium rechargeable battery. The battery featuring such an anode exhibits superior electrochemical performance, an exceptionally high specific capacity, an excellent reversible capacity, and a long cycle life.

### BACKGROUND OF THE INVENTION

1. Field of Invention

The present invention generally relates to a composite anode for a lithium rechargeable battery using silicon particles from kerf.

2. Description of the Related Art

Rechargeable lithium batteries are commonly used in portable electronic devices such as cell phones, tablet computers, and laptop computers and are also used in electric vehicles. Conventional batteries are made using spinel cathodes and graphite anodes and battery capacities are limited to approximately 100 mAh·g⁻¹. There is considerable interest in new electrode materials that would increase the capacity of lithium rechargeable batteries.

Silicon has become a promising candidate to replace graphite as an anode material for lithium rechargeable batteries. Silicon has a theoretical capacity for lithium storage of 4200 mAh·g⁻¹, which is over ten times higher than that of conventional graphite. In recent years, silicon has been applied for lithium rechargeable batteries in the form of pure silicon anodes and composite anodes. Recent literature with nano-scale silicon in lithium rechargeable cells, including silicon nanowires, structured silicon particles, 3-D structured silicon nanoclusters, and etc., have shown that near theoretical capacities are achievable; unfortunately, capacity losses remain significant.

Composite anodes with silicon particles and other active and inactive materials have been applied in lithium rechargeable batteries. U.S. Pat. No. 7,951,242, U.S. Pat. No. 8,273,478, U.S. Pat. No. 8,236,454 and U.S. Pat. No. 8,173,299 describe lithium rechargeable battery containing composite negative electrode with elemental silicon. According to U.S. Pat. No. 8,263,265, an Si/C composite includes carbon dispersed in porous silicon particles. The Si/C composite may be used to form an anode active material to provide a lithium battery having a high capacity and excellent capacity retention. U.S. Pat. No. 8,211,569 describes a rechargeable lithium battery including a negative electrode made by sintering, on a surface of a conductive metal foil as a current collector, a layer of a mixture of active material particles containing silicon and/or a silicon alloy. U.S. Pat. No. 8,071,238 also describes silicon-containing alloys useful as electrodes for lithium-ion batteries. Other journal publications also suggest that silicon can be integrated into composite anode matrix for battery anodes, and improved capacity (500-1000 mAh·g⁻¹) can be obtained for over hundreds of cycles for these anodes. The limited anode capacity and cycle life still pose as barrier for practical applications of silicon composite anodes.

It has been reported recently that doped silicon as anode material for lithium rechargeable batteries is able reduce electrode electrical resistance and improve electrochemical performance. Boron-doped porous silicon nanowire showed high electron conductivity compared to silicon nanowires without doping, and maintained high reversible capacity of 2000 mAh·g⁻¹ for 250 cycles. (Zhou et al. 2012). Phosphorous-doped silicon nanowires showed initial discharge capacities higher than those of the pristine ones under various rate capabilities. The charge transfer resistance was significantly reduced by the existence of phosphorus on the surface of silicon nanowire electrodes as suggested via electrochemical impedance analysis, The presence of the phosphorus component in the silicon nanowires significantly improved the electrochemical performance due to reduced interfacial resistance (Lee et al. 2012).

Silicon in composite anode for lithium rechargeable batteries may be sourced from silicon kerf. Currently, about 80% of the initial metallurgical-grade silicon material is wasted in the form of kerf during the process of making silicon solar cells or wafers. Depending on wafer thickness, kerf loss represents from 25% to 50% of the silicon ingot material. The silicon kerf maintains the same doping level of the silicon ingot material, and contains solvents, oils, impurities such as silicon carbides, and the native oxide at the surface of waste silicon particles. Silicon kerf can be obtained from semiconductor manufacturers at lower cost compared to intrinsic silicon particles. Silicon kerf with doped silicon particles may greatly improve conductivity for composite anodes, so as to show superior electrochemical performance for lithium rechargeable batteries.

Due to the demand for higher capacity batteries and a valuable source of silicon, recycling silicon particles from silicon kerf to create anodes for lithium rechargeable batteries would be extremely desirable. Thus, there exists great value in recovering silicon kerf, processing the kerf, and using the processed silicon particles in a lithium rechargeable battery anode.

### SUMMARY OF THE INVENTION

In one embodiment of the present invention, a composite anode comprising silicon particles from kerf, carbonaceous materials, other anode active material, a polymer binder and a current collector.

In another embodiment of the present invention, an energy storage device comprising the composite anode, a cathode, an electrolyte, and a separator between the anode and the cathode.

### BRIEF DESCRIPTION OF THE DRAWING

FIG. 1 is an SEM image of a composite anode comprising silicon particles from kerf.

FIG. 2 is the charge/discharge performance of a lithium-ion cell containing a silicon composite anode, comprising silicon particles from silicon kerf.

### DETAILED DESCRIPTION OF THE INVENTION

The present invention is believed to be applicable to a variety of different types of lithium rechargeable batteries and devices and arrangement involving silicon composite electrodes. While the present invention is not necessarily limited, various aspects of the invention may be appreciated through a discussion of examples using the context.

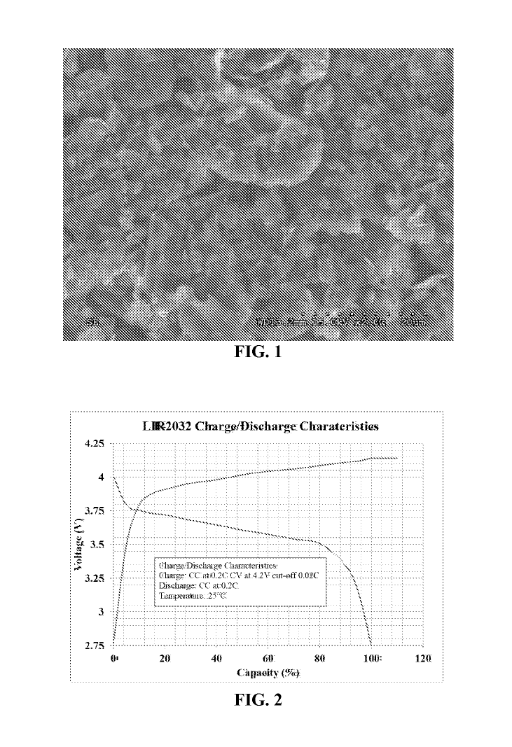

In one embodiment of the present invention, a composite anode is comprised of silicon particles from silicon kerf, carbonaceous materials, and polymer binder. Silicon kerf is comprised of silicon particles, silicon carbide particles, organic solvents such as glycols, and other impurities. Silicon particles in silicon kerf are in micrometers scale (FIG. 1). Silicon particles from silicon kerf can be formed into a composite matrix with carbonaceous materials, and polymer binder to use as an anode for lithium rechargeable battery.

Said silicon particles from silicon kerf have a size range from 10 nanometers to 10 micrometers with a preferred range from 50 nanometers to 500 nanometers, with a more preferred range from 100 nanometers to 300 nanometers. Weight percent of said silicon particles is ranging from 0.5% to 50% with a preferred range from 5% to 40%, with a more preferred range from 15% to 30% based on the weight of the composite anode.

Said silicon particles from kerf may include silicon carbide. Silicon carbide present in said silicon particles in an amount of less than 1%, with a preferred amount of less than 0.1%. Silicon particles may include dopants such boron, phosphorous, arsenic, or antimony, and combinations thereof. Dopant present in said silicon particles in an amount ranging from 10E10 to 10E21 atoms per cubic centimeter.

The carbonaceous materials may be obtained from various sources, examples of which may include but not limited to petroleum pitches, coal tar pitches, petroleum cokes, flake coke, natural graphite, synthetic graphite, soft carbons, as well as other carbonaceous material that are known in the manufacture of prior art electrodes, although these sources are not elucidated here. The polymer binder may be, but not limited to, polyvinylidene fluoride, sodium carboxymethyl cellulose, styrene-butadiene rubber, and etc. The composite matrix comprising silicon particles from silicon kerf, carbonaceous materials, and polymer binder can be attached to a current collector. The current collector can be metallic copper film with a preferred thickness of 10 micrometers to 100 micrometers. In this fashion, the arrangement can be used as an anode in a lithium rechargeable battery.

Said silicon particles are formed into a composite matrix with carbonaceous materials, and polymer binder for use as an anode for lithium rechargeable battery. Weight percent of said silicon particles is ranging from 0.5% to 50% with a preferred range from 5% to 50%, with a more preferred range from 10% to 30% based on the weight of active materials in the composite. The carbonaceous materials may be obtained from various sources, examples of which may include but not limited to petroleum pitches, coal tar pitches, petroleum cokes, flake coke, natural graphite, synthetic graphite, soft carbons, as well as other carbonaceous material that are known in the manufacture of prior art electrodes, although these sources are not elucidated here. The polymer binder may be, but not limited to, polyvinylidene fluoride, sodium carboxymethyl cellulose, styrene-butadiene rubber, and etc. The composite matrix comprising silicon particles from silicon kerf, carbonaceous materials, and polymer binder can be attached to a current collector. The current collector can be metallic copper film with a preferred thickness of 10 micrometers to 100 micrometers. In this fashion, the arrangement can be used as an anode in a lithium rechargeable battery.

In another embodiment of the present invention, an energy storage device is implemented with the anode, a cathode, an electrolyte, and a separator between the anode and the cathode. The cathode is comprised of lithium salts such as lithium manganese oxide, lithium cobalt oxide, lithium ion phosphate, and etc.; carbonaceous materials, and a polymer binder. The electrolyte can be a mixture of a lithium compound and an organic carbonate solution. The lithium compound may be, but not limited to lithium hexafluorophosphate, lithium perchloride, lithium bix(oxatlato)borate, and etc. The separator membrane can be a multiple polymer membrane. The organic solution may be comprised of but not limited to any combination of the following species: ethylene carbonate, dimethyl carbonate, diethyl carbonate, propylene carbonate, vinylene carbonate, and etc.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

### EXAMPLES

While embodiments have been generally described, the following examples demonstrate particular embodiments in practice and advantage thereof. The examples are given by way of illustration only and are not intended to limit the specification or the claims in any manner. The following illustrates exemplary details as well as characteristics of such surface modified silicon particles as the active anode materials for lithium rechargeable batteries.

In this example, 100 grams of silicon kerf slurry (approximately 50 vol. % diameter larger than 2 micrometers and approximately 50 vol. % diameter ranging from 0.5 micrometer to 100 nanometers) can be mixed with 100 milliliters of anhydrous methanol as co-solvent in a 2 liters ceramic ball mill container with 75 grams of stainless balls (average diameter 4 millimeters). The resulting mixture is milled for 8 hours at 25 degree Celsius.

The resulting slurry was filtered using filter paper with a filtration membrane (pore size of 500 nanometers). Said silicon particles obtained from abovementioned process have diameter less than 500 nanometers, and approximately 10 grams of silicon particles is obtained from the process.

Approximately 0.5 grams of the recovered silicon particles were cleaned using 10 milliliters of 1% hydrofluoric acid aqueous solution, followed by rinsing with 10 milliliters of de-ionized water for three times. The silicon particles were heated at 75 degrees Celsius until completely dry under argon atmosphere.

The cleaned particles were well mixed with 0.5 grams of carbon black (average particle size below 50 nanometer), 3.5 grams of natural graphite (average particle size below 40 micrometer), and 10 milliliters 5 wt. % polyvinylidene fluoride in n-methylpyrrolidone solution (equivalent to 0.5 grams of polyvinylidene fluoride). The resulting mixture was applied to a copper foil (˜25 micrometers thick) using the doctor blade method to deposit a layer of approximately 100 micrometers. The film is then dried in vacuum at 120 degree Celsius for 24 hours.

The resulting anode was assembled and evaluated in lithium secondary coin cell CR2032 with lithium cobalt oxide as the other electrode. A disk of 1.86 cm² was punched from the film as the anode, and the anode active material weight is approximately 5 micrograms. The other electrode was a lithium cobalt oxide cathode with a thickness of 100 micrometers and had the same surface area as the anode. A microporous trilayer polymer membrane was used as separator between the two electrodes. Approximately 1 milliliter 1 molar LiPF.sub.6 in a solvent mix comprising ethylene carbonate and dimethyl carbonate with 1:1 volume ratio was used as the electrolyte in the lithium cell. All above experiments were carried out in glove box system under an argon atmosphere with less then 1 part per million water and oxygen.

The assembled lithium coin cell was removed from the glove box and stored in ambient conditions for another 24 hours prior to testing. The coin cell was charged and discharged at a constant current of 0.5 mA, and the charge and discharge rate is approximately C/5 from 2.75 V to 4.2 V versus lithium for over 100 cycles.

FIG. 2 shows the charge and discharge capacities over cell potential of the sample coin cell after 100 charge and discharge cycles. Reversible capacity of over 160 mAh·g⁻¹ can be maintained after over 100 cycles with above 80% depth of discharge.

The preferred embodiment of the present invention has been disclosed and illustrated. The invention, however, is intended to be as broad as defined in the claims below. Those skilled in the art maybe able to study the preferred embodiments and identify other ways to practice the invention those are not exactly as described herein. It is the intent of the inventors that variations and equivalents of the invention are with in the scope of the claims below and the description, abstract and drawings are not to be used to limit the scope of the invention.

The invention claimed is:

1. A composite anode for a lithium rechargeable battery comprising silicon particles from silicon kerf, carbonaceous materials, other anode active materials, a polymer binder and a current collector.

2. A composite anode according to claim 1 wherein size of said silicon particles is ranging from 10 nanometers to 10 micrometers with a preferred range from 50 nanometers to 500 nanometers, with a more preferred range from 100 nanometers to 300 nanometers.

3. A composite anode according to claim 1 wherein said silicon particles are present in the anode in an amount ranging from 0.5% to 50% with a preferred range from 5% to 40%, and with a more preferred range from 15% to 30% based on the weight of the composite anode.

4. A composite anode according to claim 1, wherein said silicon particles include silicon carbide. Silicon carbide present in said silicon particles is in an amount of less than 1%, with a preferred amount of less than 0.1%.

5. A composite anode according to claim 1 wherein said silicon particles include dopants such as boron, phosphorous, arsenic, or antimony, and combinations thereof. Dopants present in said silicon particles are in an amount ranging from 10E10 to 10E21 atoms per cubic centimeter.

6. A composite anode according to claim 1 wherein said silicon particles are combined with carbonaceous materials, other anode active materials and a polymer binder into composite.

7. A composite anode according to claim 1 wherein carbonaceous materials are from a variety of carbon sources, including graphite, carbon black, pitch or acetylene black.

8. A composite anode according to claim 1 wherein the other anode active materials are from a variety of materials that can reversibly store lithium, such as tin, titanate, or germanium, and combinations thereof.

9. A composite anode according to claim 1 wherein the polymer binder are from a variety of polymers, including polyvinylidene fluoride, sodium carboxymethyl cellulose or styrene-butadiene rubber.

10. A composite anode according to claim 1 is attached to a current collector for use as an anode for a lithium rechargeable battery.

11. An energy storage device, comprising the anode according to claim 1, a cathode, an electrolyte, and a separator between the anode and the cathode.

12. The energy storage device of claim 11 wherein the cathode is comprised of lithium salts such as lithium manganese oxide, lithium cobalt oxide, lithium ion phosphate, and etc; carbonaceous materials, a polymer binder, and a current collector.

13. The energy storage device of claim 11 wherein the electrolyte can be a mixture of a lithium compound and an organic carbonate solution. The lithium compound is, but not limited to lithium hexafluorophosphate, lithium perchloride, lithium bix(oxatlato)borate, and etc. The organic solution is comprised of but not limited to any combination of the following species: ethylene carbonate, dimethyl carbonate, diethyl carbonate, propylene carbonate, vinylene carbonate, and etc.

14. The energy storage device of claim 11 wherein the separator is a microporous polymer membrane.
